(19) United States
(12) Patent Application Publication
(10) Pub. No.: US 2008/0176198 A1
(43) Pub. Date: Jul. 24, 2008

(54) System and method for dental education simulation

(76) Inventors: Murtuza Ansari, Orangeburg, SC (US); Abrar Adil, Kokomo, IN (US)

Correspondence Address: Ralph A. Dowell of DOWELL & DOWELL P.C., 2111 Eisenhower Ave, Suite 406, Alexandria, VA, 22314, US

(21) Appl. No.: 11/902,136

(22) Filed: Sep. 19, 2007

Related U.S. Application Data
(60) Provisional application No. 60/881,188, filed on Jan. 19, 2007.

(51) Int. Cl. G09B 23/30

(52) U.S. Cl. 434/263; 434/270

(57) ABSTRACT

A dental anesthesia simulator for dental procedure training is provided comprising a dental mannequin constructed of an acrylic material, comprising an upper and lower jaw portion covered by replaceable mucous membrane textures; a flexible position sensor for determining the location of an instrument, wherein the sensor means is located between the upper and lower jaw portions and the replaceable mucous membrane textures; and a processor means for processing information from the flexible position sensor regarding the location of the instrument.

### CROSS-REFERENCE TO RELATED APPLICATIONS

The present application claims priority to U.S. provisional patent application No. 60/881,188, filed on Jan. 19, 2007, entitled “System and Method for Dental Education Simulation,” which is hereby incorporated by reference in its entirety.

### FIELD OF THE INVENTION

The present invention relates to a system and method for facilitating dental education, and more specifically to a system and method for providing instructions and practice for dental anesthetic education.

### BACKGROUND OF THE INVENTION

Dental education currently involves student exposure to patients in the upper years of their education. While students are exposed to patient environments, they are exposed to patients only when the case that presents itself is suitable to their level of abilities. As such, many procedures in dentistry will be practiced by students only a handful of times, if that, before they graduate.

Some basic dental procedures which are vital to the practice of dentistry, such as the administering of anesthetic are performed by students very few times in patient settings. Often, where students need to improve in certain areas, their ability to engage in extra dental procedures is limited, due to limited resources.

As a result, simulation devices have been developed, that allow students to practice certain skills that are required in the practice of dentistry. However, even with the development of these simulation devices, they are limited in the feedback and instruction they provide. Often, due to the shortage of educators, students engage with these simulation devices, with little or no oversight, and the student is unable to receive appropriate feedback as to their progress.

### SUMMARY OF THE INVENTION

In a first aspect of the invention, a dental anesthesia simulator for dental procedure training is provided. The dental anesthesia simulator comprises a dental mannequin constructed of an acrylic material, comprising an upper and lower jaw portion covered by replaceable mucous membrane textures; a flexible position sensor for determining the location of an instrument, wherein the sensor means is located between the upper and lower jaw portions and the replaceable mucous membrane textures; and a processor means for processing information from the flexible position sensor regarding the location of the instrument.

### BRIEF DESCRIPTION OF THE DRAWINGS

For a better understanding of embodiments of the systems and methods described herein, and to show more clearly how they may be carried into effect, reference will be made by way of example, to the accompanying drawings in which:

FIG. 1 is a diagram illustrating the mandibular nerve;

FIG. 2 is a block diagram illustrating the components of a dental simulator device;

FIG. 3 is a block diagram illustrating the components of a dental mannequin in an exemplary embodiment;

FIG. 4 is a block diagram illustrating the components of an interface circuit;

FIG. 5 is a block diagram illustrating the components of a computing station;

FIG. 6 is a flowchart illustrating the steps of a data transmission method;

FIG. 7 is a flowchart illustrating the steps of a position determination method;

FIG. 8 is a block diagram illustrating the components of the simulator application.

### DETAILED DESCRIPTION OF THE INVENTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

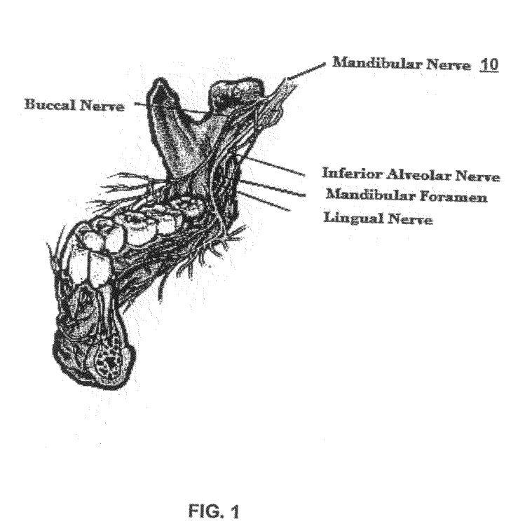

Reference is made to FIG. 1, where a diagram illustrating the mandibular nerve 10 is shown. The mandibular nerve 10 is shown for purposes of example, and is shown to illustrate anatomical areas for which a dental simulation device as described below may be developed. The various anatomical areas, of which the mandibular nerve block 10 is one, may be modeled with the simulation device, and therefore allow educators and students (referred to collectively as “users”) to perform clinical practice assessments. The mandibular nerve 10 is used to highlight in an exemplary embodiment, one procedure that may be practiced with the simulator device, the mandibular nerve block. The mandibular nerve block, is an anesthetic procedure, that allows surgical and other such procedures to be performed on the mandible under anesthetic. Other such procedures, may be practiced with the simulation device, including the mental nerve block. A mental nerve block is an anesthetic procedure that allows the nerve that emerges between the mental foramen, which is located below and between the apices of the premolars to be injected with anesthetic. The blocking of the mental nerve anesthetizes the first premolar tooth, the anterior buccal mucosa and the lower lip. The dental simulation device, as described below is not limited to allowing for skill development in the above mentioned anesthetic procedures. The simulation device is designed for fostering skill development, with respect to any dental procedures that require engaging a dental instrument in a dental setting with a patient.

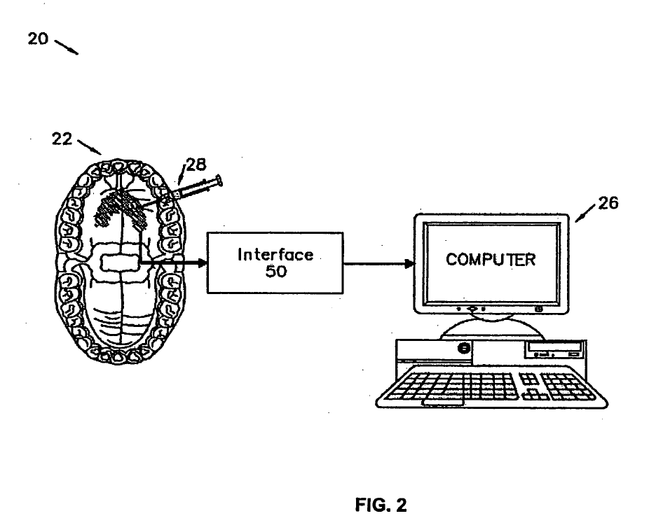

Reference is now made to FIG. 2, where an exemplary embodiment of a dental simulator device 20 is shown. The dental simulator device 20, is comprised of a dental mannequin 22, and an interface circuit 50 and a computing station 26. The student or educator engages the dental mannequin with dental instruments 28. The dental instruments 28, may include but are not limited to needles, scalpels, suturing equipment, a trocar, a cannula, and any other such instrument that is capable of exerting pressure on a specific area of the human mouth. When the dental mannequin 22 is engaged by the dental instrument 28, the resulting positional data, indicating the position of the instrument is computed and transmitted to the computing station 26, and is presented to the user.

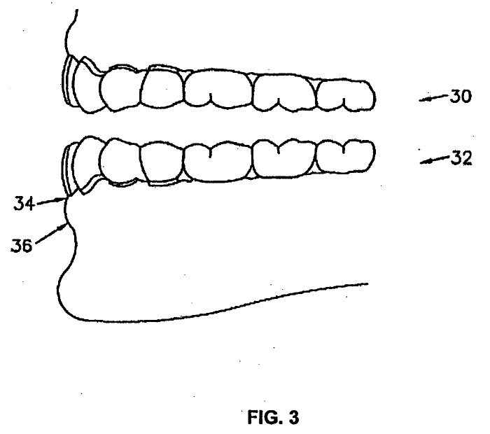

Reference is now made to FIG. 3, where a block diagram illustrating the components of a dental mannequin 22, in an exemplary embodiment is shown. The dental mannequin 22 may represent any specific area of a human or animal mouth. In an exemplary embodiment, the dental mannequin 22 is described with reference to a representation of a human jaw However, as is well understood, the mannequin 22 may be modeled as representative of any area of a human or animal mouth. In an exemplary embodiment, the mannequin is comprised of an upper jaw portion 30, a lower jaw portion 32, membrane textures 34, and one or more position sensors 36. The upper and lower jaw portions 30 and 32, respectively, are constructed of acrylic materials in an exemplary embodiment. The upper and lower jaw portions, in an exemplary embodiment, include a full set of teeth that are found in a human. The gum portions of the mannequin 22, in an exemplary embodiment are comprised of membrane textures 34. The membrane textures, in an exemplary embodiment are fashioned from a biolike or simulab material. The membrane textures 34 are moldable, and therefore when necessary, the membrane textures 34 of the mannequin may be removed, and replaced with new membrane textures. Between the membrane textures 34 and the acrylic material of the upper and lower jaw portions a position sensor 36 is found. In an exemplary embodiment, the position sensor 36 is made from a flexible material, and is a flexible linear potentiometer. In an exemplary embodiment, the flexible linear potentiometer is manufactured by Spectrasybol Inc., and may vary in length between 150 mm and 350 mm, with a variance of ±1% for tolerance. A potentiometer is used to measure an electromotive force or voltage, by having opposed to it a known potential drop. The potential drop is established by passing a definite current through a resistor. The potentiometer through determining differences in voltage, as explained below, is used by the computing station to facilitate dental education. As the position sensor 34, is composed from flexible material, it is located under any area (the representation of the gums) upon a dental mannequin 22 where an instrument may be engaged. Therefore, any area covered by mucous membranes may be engaged by an instrument, and the resulting positional data in relation to the dimensions of the mannequin are processed and presented to the user. The operation of the position sensor 34 is explained in further detail below.

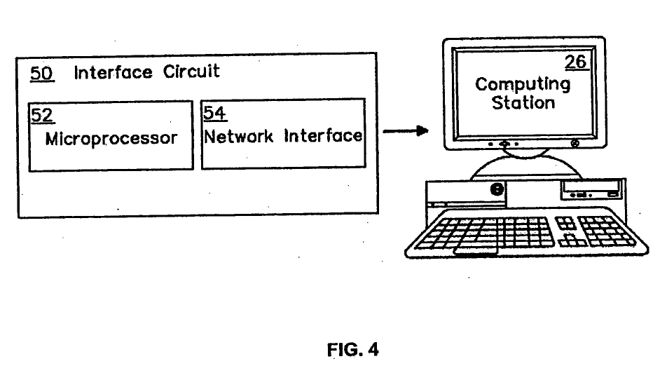

Reference is now made to FIG. 4, where the interaction between position sensor 34 and an interface circuit 50 are shown in one exemplary embodiment. As discussed above, the position sensor 34 in the exemplary embodiment is a flexible linear potentiometer. In alternative embodiments, the position sensor may be a flexible switch membrane. As is understood by one skilled in the art, a potentiometer is used to measure the potential (or voltage) in a circuit by sampling of a portion of a known voltage from a resistive slide wire and comparing it with the unknown voltage by means of a voltmeter. The potentiometer in an exemplary embodiment is comprised of two layers of static resistive elements, that have between them a sliding contact, also referred to as a wiper (not shown). The wiper transverses between the resistive elements. The static resistive elements are comprised of polymeric carbon ink. The wiper element is constructed from an ultra-thin spacer that runs the length of the resistive elements. In an exemplary embodiment, a protective lining is placed between the acrylic material and the potentiometer. The protective lining may be a protective rubber lining.

The flexible linear potentiometer connects to an electrical interface circuit 50, that comprises a microprocessor 52 and a network interface 54 that is used to transmit data to and receive data from a computing station 26.

The position sensing means 34 is sensitive to any pressure applied to it. In an exemplary embodiment, the position sensor is sensitive to pressure application of at least 3 oz that is applied. By applying pressure on the position sensor 34, the resistance level between the wiper and the static resistive elements change. By reading this difference in resistance, a position is determined as described in detail below. The microprocessor 52 determines the position upon the potentiometer that has been engaged. The network interface 54 allows the readings from the potentiometer to be taken and transmitted to a computing station 26. The network interface 54 may include, but is not limited to, a USB interface, a wireless interface, a parallel port connection, infrared connection, a RS-232 connection, or any other suitable wired or wireless connection that allows data to be transmitted to and from a computing station.

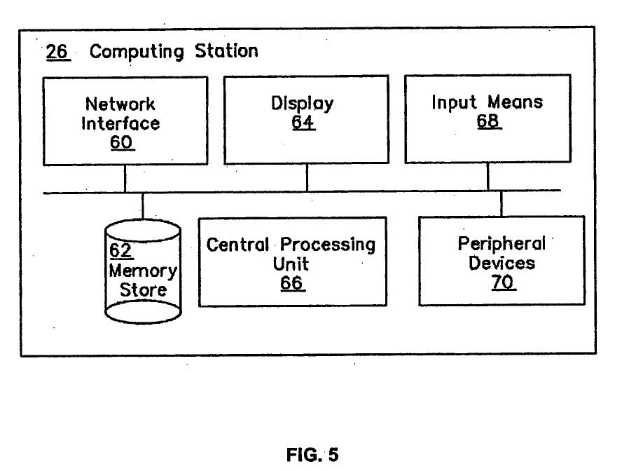

Reference is now made to FIG. 5, where the constituent components of a computing station 26 are illustrated in one exemplary embodiment. The computing station 26, in an exemplary embodiment, has associated with it, a computing station network interface 60, a memory store 62, a display 64, a central processing unit 66, an input means 68, and peripheral devices 70.

The computing station network interface 60 enables the respective station to connect to the interface circuit 50 or any other machine, system or service accessible through a network connection. The network interface 50 may be a conventional network card, such as an Ethernet card, wireless card, or any other means that allows for communication. The memory store 62 is used to store executable programs and other information, and may include storage means such as conventional disk drives, hard drives, CD ROMS, or any other non volatile memory means. In an exemplary embodiment, the memory store has resident upon it a simulator application 61. The simulator application 61 as described below, allows an educator or student to engage with a dental simulation device 20, by following instructions presented upon a computing station 26 in an exemplary embodiment. The computing station 26, and more specifically the simulation application 61 instructs the educator or student. The operation of the simulation application is discussed in further detail below. The display 64 displays the information to upon a monitor type device. The CPU 66 is used to execute instructions and commands that are loaded from the memory store 62. The input means 68 allows users to enter commands and information into the respective station. Computing stations 26 may have associated with them one or more input means 68, which may include, but are not limited to, any combinations of keyboards, a pointing device such as a mouse, or other means such as microphones. Peripheral devices 70 such as printers, scanners, and other such devices may also be associated with the computing station 26.

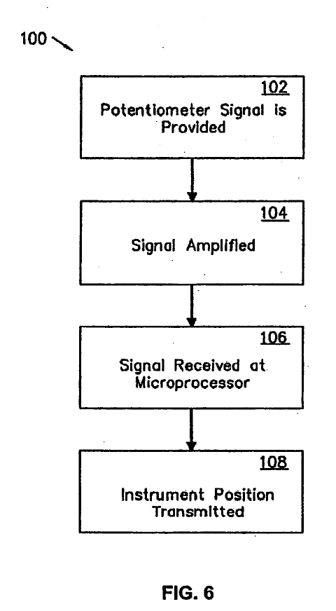

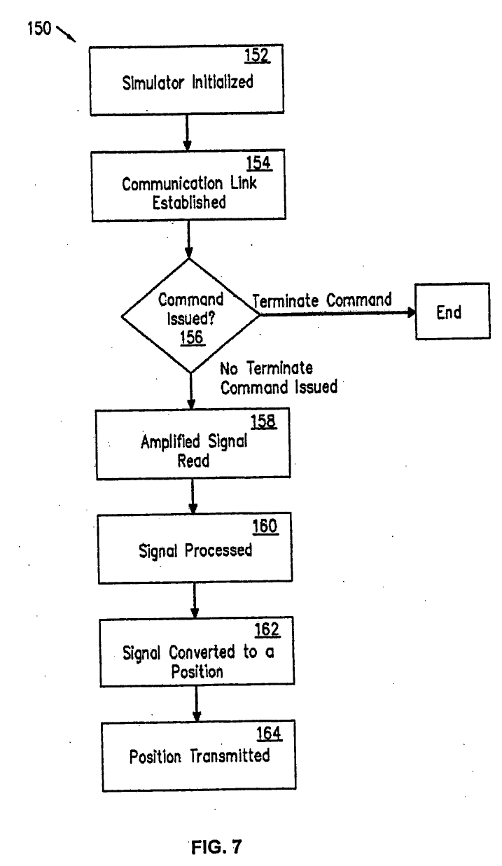

Reference is now made to FIG. 6, where a flowchart illustrating the steps of a data transmission method 100 are shown. The data transmission method 100 provides for positional data readings that are determined by the position sensor 34 to be processed and transmitted to the computing station. Method 100 begins at step 102, where the position sensor provides a potentiometer signal. The potentiometer signal is provided where any pressure is detected by the potentiometer. As discussed above, pressure is detected upon the potentiometer where a dental instrument engages any area upon the mannequin 22. A DC voltage is continuously applied to the potentiometer, and in an exemplary embodiment, the potentiometer data is read every 5 ms. However, it should be understood that the potentiometer data can be read at various other intervals of time. Method 100 then proceeds to step 104, where the signal from the potentiometer is amplified. Method 100 then proceeds to step 106, where the amplified signal is received at the microprocessor 52. At the microprocessor 52, the signal is converted from analog to digital. The mircoprocessor 52 at step 106, determines the position of the instrument, as is explained in further detail below with regards to FIG. 7. At step 106, as part of the processing of the signal to determine the position of the a low pass filter is implemented in order to reduce or eliminate any noise associated with the potentiometer signal. Method 100 then proceeds to step 108, where the instrument position that has been determined by the microprocessor is transmitted to the computing station.

Reference is now made to FIG. 7, where a flowchart illustrating the steps of a position determination method 150 is shown. The position determination 150, in an exemplary embodiment, is undertaken at the interface circuit 50, based on commands received from the computing station 26. Method 150 begins at step 152 where the simulator is initialized. The system initialization involves the requisite processors performing self tests to ensure that the system is performing property, and where the potentiometer readings are read constantly. Method 150 then proceeds to step 154, where a communication link is established via the respective interface with the computing station 26. The communication link 26 between the interface circuit 50 and the computing station 26 allows for data to be transmitted between the interface circuit 50 and the computing station 26. Method 150 in an exemplary embodiment then proceeds to step 156, where the interface circuit 50 checks to determine whether the computing station 26 has issued a command. In an exemplary embodiment, the computing station 26 may issue one or more commands to the interface circuit 50. As the instructional session (where a computing station instructs a user to engage the simulation device) may be conducted by following instructions that are presented on the computing station 26, the computing station 26 may issue commands to the interface circuit 50. In an exemplary embodiment, the commands may be issued when the user is expected to engage the device with an instrument, or when an instructional session has ended. When an instructional session has ended, the computing station 26 provides a command instructing the interface circuit 50, and more specifically the microprocessor 52 to stop processing potentiometer readings that are received. If at step 156, it is determined that a terminate or stop command is received from the computing station 26, method 150 terminates. If at step 156, it is determined that the computing station 26 has not issued a terminate or stop command, method 150 proceeds to step 158. At step 158, the signal from the potentiometer that has been amplified and has been converted from analog to digital is read. Upon reading the converted potentiometer signal, method 150 proceeds to step 160. At step 160, further processing is undertaken on the converted potentiometer signal. More specifically, in order to reduce the noise that is present in the respective signal, a low pass filter is applied to the signal in order to reduce noise. Upon the completion of step 160, method 150 then proceeds to step 162 where the signal is converted to a position in respect of the physical dimensions of the simulation device 20. In an exemplary embodiment, in step 162, a curve fitting algorithm is employed to determine a position based on the signal that has been received. Based on one or more coefficients that are derived, a position is determined by determining the higher polynomial as determined by the following equation:

Position: a5*r5+a4*r4+a3*r3+a2*r2+a1*r+a (Equation 1)

where a5, a4, a3, a2, a1, and a are coefficients that are derived by curve fitting a signal (measured as the resistance in ohms) vs. position. At step 162, in an exemplary embodiment, based on equation 1 the microprocessor determines a position. In an alternative embodiment, at step 162, the microprocessor 52 may use a look up table, where the signal reading that is provided in resistance is used to search a look up table or database to determine the corresponding position from the device from where it was taken, and as such, engaged by the dental instrument. Upon the determination of a position, method 150 proceeds to step 164. At step 164, the microprocessor transmits the position of the instrument to the computing station.

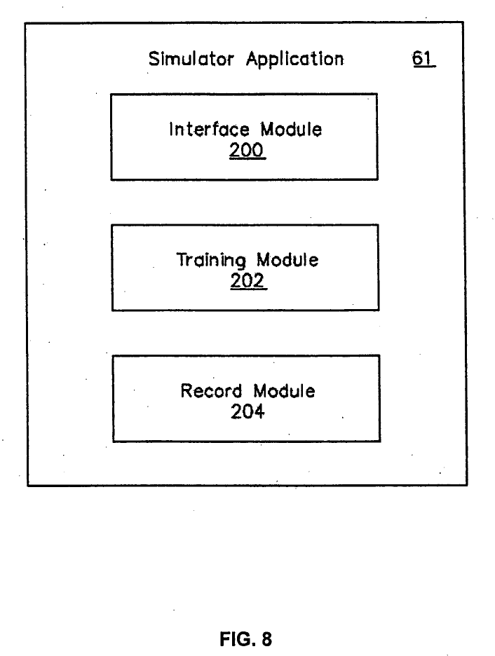

As the computing station 26 receives positional data when the simulation device 20 is engaged with an instrument 28, the computing station may be used to conduct and lead the educator and student through various training exercises. Reference is made to FIG. 8, where the constituent components of a simulator application 61 are shown in an exemplary embodiment. In an exemplary embodiment, the simulator application 61, is comprised of an interface module 200, a training module 202, and a record module 204. The interface module 200 allows for a display to be provided to the user, where a graphical display of the anatomical structure that is represented by the simulation device 20 is rendered. The graphical display of the simulation device, allows the user to select from a variety of views of the simulation device, and allows the user to zoom in on any particular area. The interface module 200, in an exemplary embodiment, is also used for training purposes, where also provides a display to the user indicating an exact area the user should engage with the dental instrument 28, and the actual area upon the mannequin 22 that was engaged. The training module 202, allows the user to select from a variety of modes of usage of the simulation device and the associated simulation application 61. In an exemplary embodiment, the user is able to use the simulation device to practice certain procedures by engaging the simulation device with the dental instruments 68, and then determining through the display presented upon the computing station the exact area that was engaged. Another mode of the training module 202, as described below, allows for one or training methods to be engaged by the respective users. In one exemplary embodiment, the educator may specify upon the computing station through selecting an area upon a representation of the anatomical structure, that the educator wishes the student to engage with a dental instrument. Upon the student engaging the actual simulation device 20 with an instrument in response to the educator's request, the training module causes to be displayed the desired area, and the actual area that was engaged. In another exemplary embodiment, the student may themselves specify a particular area, or the particular area is specified by the application 61. The record module 204, is used to track the users who engage the application 61, and includes their previous results of when the engaged the application 61 and system 20, and may be used to administer training exercises based on instructions that are provided to the users.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A dental anesthesia simulator for dental procedure training, comprising:
a) a dental mannequin including upper and lower jaw portions covered by mucous membrane textures;
b) a sensing means for sensing a location of an instrument, wherein the sensing means is located between the upper and lower jaw portions and the mucous membrane textures; and
c) a processing means for processing information from the sensing means to determine the location of the instrument.

2. The dental anesthesia simulator of claim 1, wherein the sensing means is a potentiometer.

3. The dental anesthesia simulator of claim 1, wherein the sensing means is a flexible switch membrane.

4. The dental anesthesia simulator of claim 1, wherein the processing means is programmed to determine whether injections have been delivered in a suitable area upon the mucous membrane textures or an unsuitable area upon the mucous membrane textures.

5. The dental anesthesia simulator of claim 4, further comprising an alerting means for alerting when an injection is delivered in an unsuitable area upon the mucous membrane textures.

6. The dental anesthesia simulator of claim 1, further comprising a display means for displaying the location of the instrument.

7. The dental anesthesia simulator of claim 1, wherein the instrument is a needle.

8. The dental anesthesia simulator of claim 1, wherein the instrument is a scalpel.

9. The dental anesthesia simulator of claim 1, wherein the sensing means is a linear position sensor.

10. The dental anesthesia simulator of claim 1, wherein the sensing means is a non-linear position sensor.

11. The dental anesthesia simulator of claim 1, wherein the mucous membrane textures are replaceable.

12. A system for dental anesthesia simulation, comprising:
a) applying an instrument to a dental mannequin including upper and lower jaw portions covered by mucous membrane textures;
b) sensing a location of the instrument with a sensing means located between the upper and lower jaw portions and the mucous membrane textures; and
c) determining the location of the instrument with a processing means for processing information from the sensing means.

13. The system for dental anesthesia simulation of claim 12, wherein the sensing means is a potentiometer.

14. The system for dental anesthesia simulation of claim 12, wherein the sensing means is a flexible switch membrane.

15. The system for dental anesthesia simulation of claim 12, wherein the processing means is programmed to determine whether injections have been delivered in a suitable area upon the mucous membrane textures or an unsuitable area upon the mucous membrane textures.

16. The system for dental anesthesia simulation of claim 15, further comprising alerting via an alerting means when an injection is delivered in an unsuitable area upon the mucous membrane textures.

17. The system for dental anesthesia simulation of claim 12, further comprising displaying the location of the instrument on a display means.

18. The system for dental anesthesia simulation of claim 12, wherein the sensing means is a linear position sensor.

19. The system for dental anesthesia simulation of claim 12, wherein the sensing means is a non-linear position sensor.

20. The system for dental anesthesia simulation of claim 12, wherein the mucous membrane textures are replaceable.
